(19) United States
(12) Patent Application Publication
(10) Pub. No.: US 2020/0304655 A1
(43) Pub. Date: Sep. 24, 2020

(54) Information Processing Apparatus, Software Keyboard Display Method, and Program

(71) Applicant: Konica Minolta, Inc., Tokyo (JP)

(72) Inventor: Haruna SASAKUMA, Osaka (JP)

(73) Assignee: Konica Minolta, Inc., Tokyo (JP)

(21) Appl. No.: 16/823,899

(22) Filed: Mar. 19, 2020

(30) Foreign Application Priority Data
Mar. 22, 2019 (JP) 2019-054799

(51) Int. Cl. H04N 1/00; G06F 9/451; G06F 3/0488

(52) U.S. Cl. CPC H04N 1/00384; G06F 3/04886; H04N 1/00307; G06F 9/454

(57) ABSTRACT

An information processing apparatus may be capable of communicating with a terminal device, the information processing apparatus including a hardware processor that may: cause a display to selectively display one software keyboard of a plurality of software keyboards of different types; acquire, from the terminal device, first specifying information for specifying a software keyboard being used in the terminal device; select one software keyboard from the plurality of software keyboards, based on the acquired first specifying information; and cause the display to display the selected software keyboard.

### CROSS REFERENCE TO RELATED APPLICATIONS

This application claims priority to Japanese Patent Application No. 2019-054799, filed on Mar. 22, 2019, which is incorporated herein by reference in its entirety.

### BACKGROUND

### Technological Field

The present disclosure relates to an information processing apparatus, a software keyboard display method in the information processing apparatus, and a program for controlling the information processing apparatus.

### Description of the Related art

There have been information processing apparatuses (image forming apparatuses, for example) in which a plurality of software keyboards of different types is installed. In such an information processing apparatus, the user opens a software keyboard setting screen and performs a selecting operation such as a touch operation, so that the software keyboard desired by the user is displayed on the screen of the information processing apparatus.

There also have been systems in which a terminal device and an information processing apparatus (a server, an image forming apparatus, or an image forming apparatus having a server function, for example) cooperate with each other.

For example, JP 2013-251623 A discloses, as an example of such a system, an image processing system including a mobile terminal and a multi-functional peripheral. In this image processing system, the mobile terminal transmits textual information input from an operation display unit of the mobile terminal to the multi-functional peripheral. The multi-functional peripheral receives the textual information from the mobile terminal, and reflects the textual information as characters that have been input through an operation input unit of the multi-functional peripheral. As described above, in the image processing system disclosed in JP 2013-251623 A, characters are input to an image processing apparatus with the use of a character input function of the mobile terminal.

Meanwhile, JP 2013-235438 A discloses, as an example of the above system, a screen conversion system that enables a remote operation of an application in a personal computer from a smartphone.

Further, personal terminal devices such as smartphones and tablet terminals are also widespread. Such a terminal device can switch software keyboards on a display. Personal computers (PCs) are also used on an individual basis in many cases. In a PC, the user can set an input method (in the case of Japanese, kana or romaji) to his/her liking.

However, in a case where a single information processing apparatus (an image forming apparatus, for example) is shared by a plurality of individuals, when a user wishes to use a familiar software keyboard, the user needs to perform an operation to select the software keyboard every time using the information processing apparatus. Specifically, the user need to manually perform software keyboard setting. Therefore, it takes time and effort to display a software keyboard familiar to the user.

### SUMMARY

The present disclosure has been made in view of the above problems, and aims to provide an information processing apparatus capable of automatically displaying a software keyboard familiar to a user on the information processing apparatus, a software keyboard display method in the information processing apparatus, and a program for causing the information processing apparatus to display a software keyboard.

To achieve the abovementioned object, according to an aspect of the present disclosure, an information processing apparatus capable of communicating with a terminal device reflecting one aspect of the present disclosure comprises a hardware processor that may: cause a display to selectively display one software keyboard of a plurality of software keyboards of different types; acquire, from the terminal device, first specifying information for specifying a software keyboard being used in the terminal device; select one software keyboard from the plurality of software keyboards, on the basis of the acquired first specifying information; and cause the display to display the selected software keyboard.

### BRIEF DESCRIPTION OF THE DRAWINGS

The advantages and features provided by one or more embodiments of the disclosure will become more fully understood from the detailed description given hereinbelow and the appended drawings which are given by way of illustration only, and thus are not intended as a definition of the limits of the present disclosure:

FIG. 1 is a diagram schematically showing the configuration of an image forming system;

FIG. 2 is a diagram for explaining near field communication between a terminal device and an image forming apparatus;

FIG. 3 is a block diagram showing an example hardware configuration of the image forming apparatus;

FIG. 4 is a diagram for explaining a data table stored in the image forming apparatus;

FIG. 5 is a diagram for explaining another data table stored in the image forming apparatus;

FIG. 6 is a functional block diagram for explaining the functional configuration of the image forming apparatus;

FIG. 7 is a diagram showing an example of a user interface of an operation panel of the image forming apparatus;

FIG. 8 is a diagram showing a state in which the image forming apparatus displays an e-mail creation screen after successful login;

FIG. 9 is a diagram showing a state in which the image forming apparatus displays an e-mail creation screen after successful login;

FIG. 10 is a flowchart for explaining the flow of a process to be performed in the image forming apparatus; and

FIG. 11 is a flowchart for explaining the flow of a process to be performed in the image forming apparatus.

### DETAILED DESCRIPTION OF EMBODIMENTS

Hereinafter, an image forming apparatus according to one or more embodiments of the present disclosure will be described with reference to the drawings. However, the scope of the disclosure is not limited to the disclosed embodiments. In the embodiment described below, the numbers, the amounts, and the like mentioned below do not limit the scope of the present disclosure, unless otherwise specified. Like components and equivalent components are denoted by like reference numerals, and the same explanation of them will not be repeated in some cases.

In the drawings, the sizes of components are not shown at the actual ratios, and, for easier understanding of structures, some of the ratios are modified to illustrate the structures more clearly. It should be noted that the embodiments and the modifications described below may be selectively combined as appropriate.

Although an image forming apparatus as an information processing apparatus will be described below, the information processing apparatus is not necessarily an image forming apparatus. In the following description, a multi-functional peripheral (MFP) having a server function will be described as an example of an image forming apparatus. However, the image forming apparatus is not necessarily such a multi-functional peripheral. For example, the image forming apparatus may be a monochrome printer, a color printer, or a facsimile machine. Further, the multi-functional peripheral does not necessarily have a server function. The multi-functional peripheral is only required to receive an instruction from a terminal device and perform a process based on the instruction.

### A. System Configuration

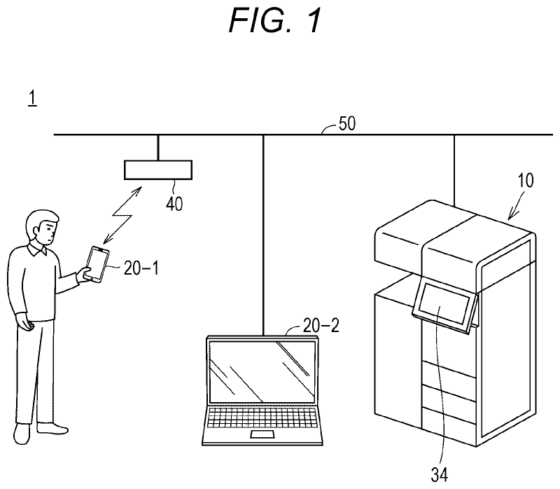

FIG. 1 is a diagram schematically showing the configuration of an image forming system 1 according to this embodiment.

As shown in FIG. 1, the image forming system 1 includes an image forming apparatus 10, a plurality of terminal devices 20 (terminal devices 20-1, 20-2, . . . ), and a wireless router 40. In this example, the terminal device 20-1 is a smartphone. The terminal device 20-2 is a notebook PC.

The image forming apparatus 10 includes an operation panel 34. The operation panel 34 includes a touch screen. A touch screen is a device in which a touch panel is placed on a display. The image forming apparatus 10 stores data for displaying a plurality of software keyboards. The image forming apparatus 10 causes the operation panel 34 to display a software keyboard designated among the software keyboards.

The terminal device 20-1 is communicably connected to the image forming apparatus 10 via the wireless router 40 and a network 50. The terminal device 20-1 is also capable of performing near field communication with the image forming apparatus 10. The terminal device 20-2 is communicably connected to the image forming apparatus 10 via the network 50.

An application program for simplifying the cooperation with the image forming apparatus 10 is installed in the terminal devices 20-1 and 20-2. This application program enables the image forming system 1 to capture scanned data and print out documents and photographs at high speed, for example. Furthermore, the terminal devices 20 can search for image forming apparatuses in the vicinity by executing the application program. Specifically, the terminal devices 20 search for image forming apparatuses installed in the vicinities of the terminal devices 20 through broadcast communication.

Such an application program (Konica Minolta Mobile Print, for example) is already known, and therefore, is not described in detail herein.

In the image forming system 1, in addition to the terminal devices 20-1 and 20-2, a plurality of terminal devices (not shown) is communicably connected to the image forming apparatus 10 via the network 50.

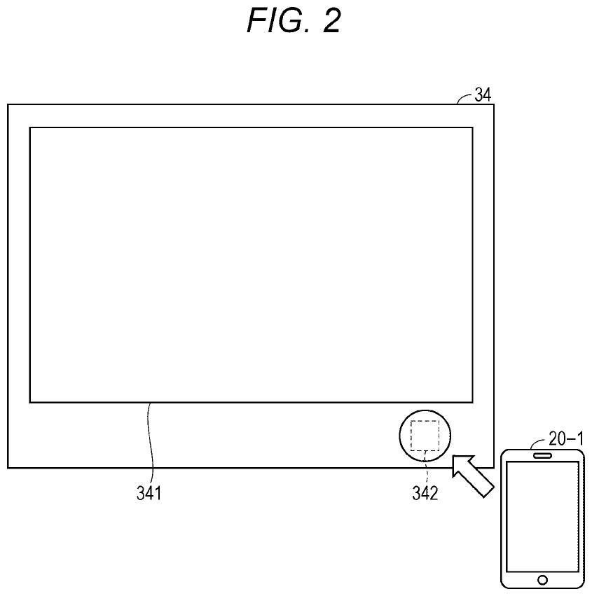

FIG. 2 is a diagram for explaining near field communication between the terminal device 20-1 and the image forming apparatus 10.

As shown in FIG. 2, the operation panel 34 includes a touch screen 341 and a communication circuit 342 for near field communication. When the user holds the terminal device 20-1 over the operation panel 34 (near the communication circuit 342), processing such as user authentication is performed.

### B. Hardware Configuration

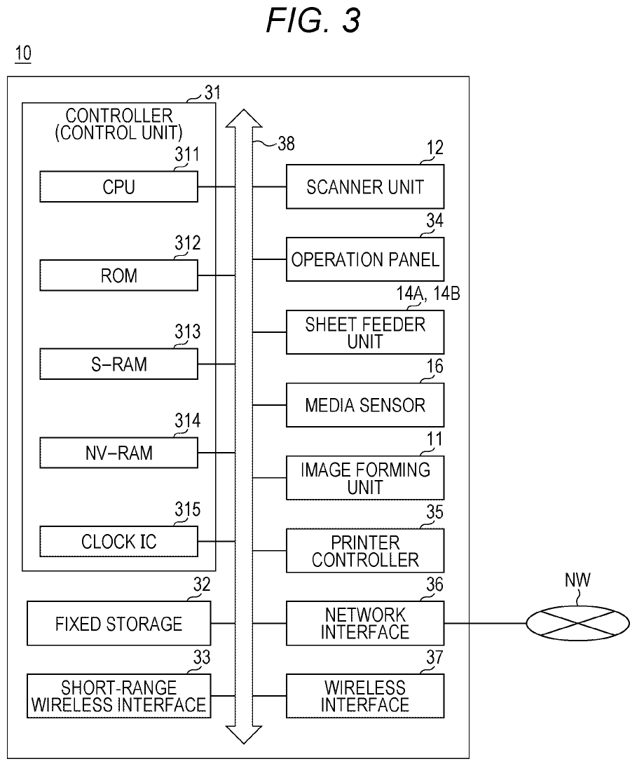

FIG. 3 is a block diagram showing an example hardware configuration of the image forming apparatus 10.

As shown in FIG. 3, the image forming apparatus 10 includes a controller 31, a fixed storage 32, a short-range wireless interface 33, a scanner unit 12, the operation panel 34, sheet feed trays 14A and 14B, a media sensor 16, an image forming unit 11, a printer controller 35, a network interface 36, and a wireless interface 37. The respective components 11, 12, 14A, 14B, 16, and 32 through 37 are connected to the controller 31 via a bus 38.

The controller 31 includes a central processing unit (CPU) 311, a read only memory (ROM) 312 in which a control program is stored, a working static random access memory (S-RAM) 313, a battery-backed nonvolatile RAM (NV-RAM) 314 storing various settings relating to image formation, and a clock integrated circuit (IC) 315. The respective components 311 through 315 are connected via the bus 38. The controller 31 controls operation of the image forming apparatus 10.

The scanner unit 12 reads an image of a document conveyed by an automatic document conveyance unit (not shown), and generates read data.

The image forming unit 11 forms an image on a paper sheet supplied from the sheet feed tray 14A or 14B, on the basis of the read data generated by the scanner unit 12 or print data acquired from the terminal device 20-1 or 20-2.

The media sensor 16 is installed in a sheet conveyance path (not shown). The media sensor 16 implements an automatic paper type sensing function.

The operation panel 34 has keys and a display unit for performing various kinds of inputs. The operation panel 34 typically includes a touch screen and hardware keys.

The network interface 36 transmits and receives various kinds of information to and from external devices such as the terminal devices 20 and other image forming apparatuses (not shown) connected thereto via the network 50.

The printer controller 35 generates a duplicate image from the print data received by the network interface 36. The image forming unit 11 forms the duplicate image on a paper sheet.

The fixed storage 32 is typically a hard disk device. The fixed storage 32 stores various kinds of data.

### C. Data

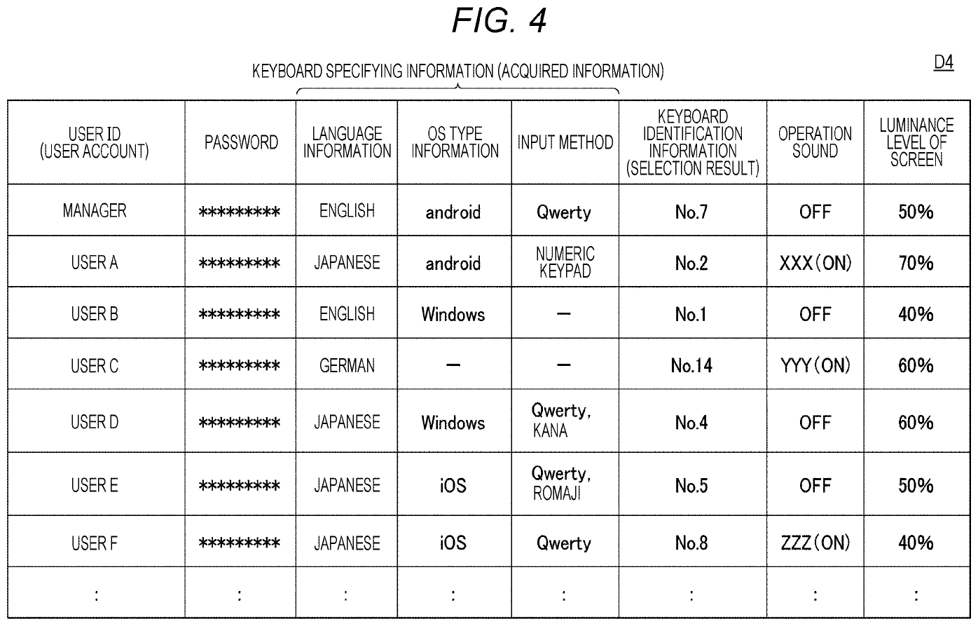

FIG. 4 is a diagram for explaining a data table D4 stored in the image forming apparatus 10.

As shown in FIG. 4, the data table D4 stores various kinds of information about each individual, such as a user ID (a user account), a password, keyboard specifying information, keyboard identification information, operation sound, and screen luminance level.

The password is stored in association with the user ID. In the description below, it is assumed that the user ID and password are registered in advance.

The keyboard specifying information is information for specifying the software keyboard being used in the terminal device. The keyboard specifying information includes language information, operating system (OS) information, and input method information. The language information is information about the language being used in the terminal device. The OS information is information indicating the OS being used in the terminal device. The input method information indicates the input method being used in the terminal device. In the case of Japanese, for example, the input method is “kana” or “romaji”.

As will be described later in detail, when the terminal device executes the application program described above, the image forming apparatus 10 acquires the keyboard specifying information from the terminal device, and stores the acquired keyboard specifying information into the data table D4. Specifically, the keyboard specifying information is associated with the user ID of the user using the terminal device, and is then stored into the data table D4.

On the basis of the keyboard specifying information acquired from the terminal device, the controller 31 of the image forming apparatus 10 selects one software keyboard from a plurality of software keyboards. In the data table D4, keyboard identification information for identifying the selected software keyboard is stored in association with the user ID.

The operation sound information is information indicating the operation sound that has been set (is being used) in the terminal device. When the terminal device executes the application program described above, the image forming apparatus 10 acquires the operation sound information from the terminal device, and stores the acquired operation sound information into the data table D4. Specifically, the operation sound information is associated with the user ID of the user using the terminal device, and is then stored into the data table D4.

The information about the screen luminance level is information indicating the luminance level of the screen of the terminal device that has been set in the terminal device. When the terminal device executes the application program described above, the image forming apparatus 10 acquires the screen luminance level from the terminal device, and stores the acquired level into the data table D4. Specifically, the screen luminance level is associated with the user ID of the user using the terminal device, and is then stored into the data table D4.

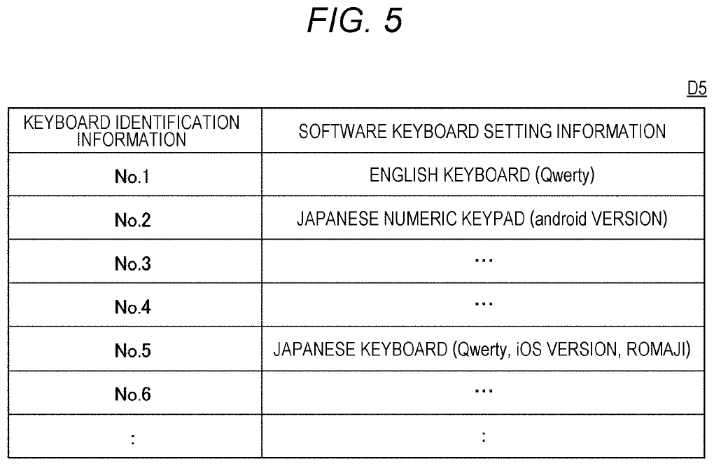

FIG. 5 is a diagram for explaining a data table D5 stored in the image forming apparatus 10.

As shown in FIG. 5, in the data table D5, keyboard identification information is associated with software keyboard setting information (keyboard types). The controller 31 refers to the contents of the data table D5, and then stores keyboard identification information into the data table D4 (FIG. 4).

Although the configuration includes the data table D4 and the data table D5 in the example described above, the configuration is not limited to this example. For example, the keyboard identification information in the data table D4 may be replaced with the “software keyboard setting information” in the data table D5 so that the data table D5 can be omitted.

### D. Functional Configuration

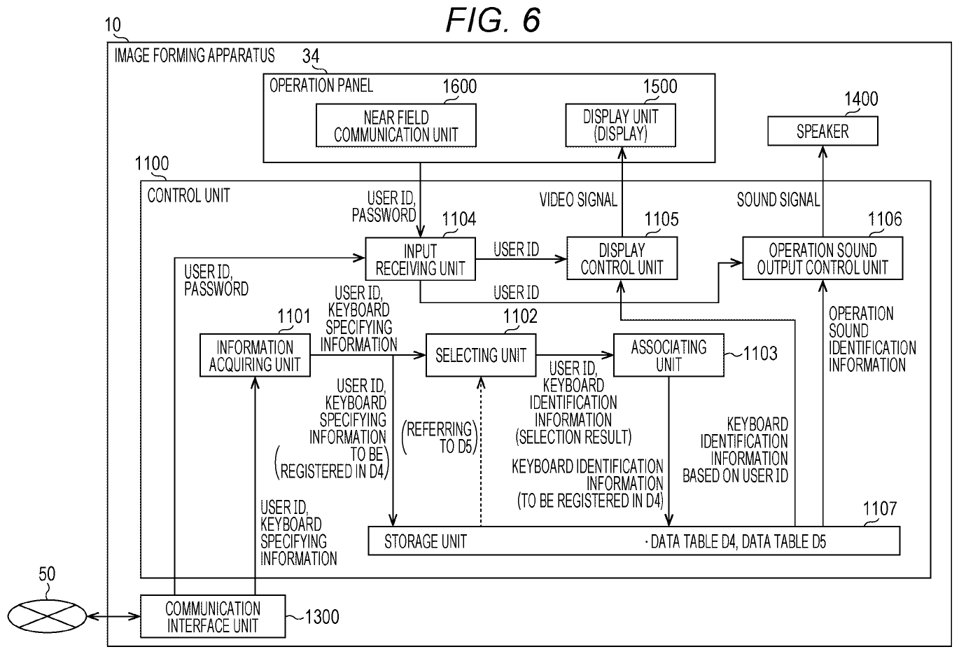

FIG. 6 is a functional block diagram for explaining the functional configuration of the image forming apparatus 10.

As shown in FIG. 6, the image forming apparatus 10 includes a control unit 1100, a communication interface unit 1300, a speaker 1400, the operation panel 34, and the fixed storage 32 (not shown). The operation panel 34 includes a display unit 1500 and a near field communication unit 1600. The speaker 1400 may be incorporated in the operation panel 34, for example.

The display unit 1500 corresponds to the display of the touch screen 341. The near field communication unit 1600 corresponds to the communication circuit 342 for near field communication (see FIG. 2).

The operation panel 34 displays various kinds of screens in accordance with an instruction from the control unit 1100. For example, the operation panel 34 displays software keys on its display. When the operation panel 34 receives an input from the user while displaying an operation screen, the operation panel 34 sends a signal corresponding to a received key to the control unit 1100. Further, when the near field communication unit 1600 performs contactless communication with a terminal device, the operation panel 34 sends data received from the terminal device to the control unit 1100. The data will be described later.

The control unit 1100 typically corresponds to the controller 31 (see FIG. 3). Typically, the control unit 1100 is formed by a processor (the CPU 311) executing the OS and various programs stored in a memory.

The control unit 1100 includes an information acquiring unit 1101, a selecting unit 1102, an associating unit 1103, an input receiving unit 1104, a display control unit 1105, an operation sound output control unit 1106, and a storage unit 1107.

The storage unit 1107 stores the data tables D4 and D5. In the control unit 1100, data is read from and written into the data tables D4 and D5. Note that the storage unit 1107 corresponds to the NV-RAM 314 (see FIG. 3). The data tables D4 and D5 may be stored in the fixed storage 32.

The communication interface unit 1300 is an interface for communicating, via the network 50 (see FIG. 1), with a terminal device connected to the network 50.

In the description below, a process to be performed by the control unit 1100 will be described in detail. For ease of explanation, the terminal device 20-1 will be described as an example of a terminal device that is communicably connected to the image forming apparatus 10. The process to be performed by the control unit 1100 with respect to the terminal device 20-1, which will be described below, is also performed in the same manner for the other terminal devices 20 (the terminal device 20-2, for example). Further, for ease of explanation, the process is divided into a plurality of phases (d1 through d4) in the description below.

### D1. Software Keyboard Display

First, a process for registering data in the data table D4 (see FIG. 4) is described.

The information acquiring unit 1101 acquires, from the terminal device 20-1, the user ID for identifying the user of the terminal device 20-1 and the keyboard specifying information for specifying the software keyboard being used in the terminal device 20-1, via the communication interface unit 1300. Specifically, the information acquiring unit 1101 acquires keyboard specifying information from the terminal device 20-1, using an application program that is installed in the terminal device 20-1 and causes the image forming apparatus 10 to execute a job.

As shown in FIG. 4, the keyboard specifying information includes at least one piece of the following information: language information about the software keyboard being used in the terminal device 20-1, OS type information about the terminal device, and the input method adopted in the software keyboard being used in the terminal device 20-1. Typically, the keyboard specifying information includes management information base (MIB) information. The MIB information includes country information and OS information.

The information acquiring unit 1101 writes the user ID and the keyboard specifying information into the data table D4 (see FIG. 4) in the storage unit 1107. The information acquiring unit 1101 also sends the user ID and the keyboard specifying information to the selecting unit 1102.

On the basis of the keyboard specifying information, the selecting unit 1102 selects one software keyboard from a plurality of software keyboards. The selecting unit 1102 identifies the identification information about the selected software keyboard, on the basis of the data table D5. The selecting unit 1102 sends the identified identification information (which is the keyboard identification information for identifying the selected software keyboard), as well as the user ID received from the information acquiring unit 1101, to the associating unit 1103.

The associating unit 1103 associates the keyboard identification information received from the selecting unit 1102 with the user ID, and stores the keyboard identification information and the user ID into the data table D4 (see FIG. 4) in the storage unit 1107. Specifically, the associating unit 1103 writes the keyboard identification information received from the selecting unit 1102 into the entry field (in the data table D4) for the keyboard identification information corresponding to the same user ID as the user ID received from the selecting unit 1102.

As the control unit 1100 performs such a series of processes, the data table D4 (excluding the data of operation sound and screen luminance level) as shown in FIG. 4 is generated.

The description below is an explanation of a process of causing the display unit 1500 of the operation panel 34 to display a software keyboard to the liking of the user who is about to use the image forming apparatus 10, by using the data table D4 after the registration process shown in the data table D4 is completed.

The input receiving unit 1104 receives an input of a user ID and a password. For example, the input receiving unit 1104 receives an input of a user ID and a password via the near field communication unit 1600 or the communication interface unit 1300. After receiving the user ID and the password, the input receiving unit 1104 performs authentication. If the authentication is successful, the image forming apparatus 10 enters a login state. In a case where the authentication is successful, the input receiving unit 1104 notifies the display control unit 1105 of the user ID.

The display control unit 1105 causes the display to selectively display one of the software keyboards of different types. Specifically, when the input receiving unit 1104 receives a user ID after the registration in the data table D4 is completed (or after the association is completed), the display control unit 1105 causes the display to display the software keyboard having the keyboard identification information associated with the user ID.

More specifically, upon receipt of a user ID from the input receiving unit 1104, the display control unit 1105 refers to the data table D4 in the storage unit 1107, and acquires the keyboard identification information associated with the user ID. The display control unit 1105 further refers to the data table D5, and acquires the software keyboard setting information (the keyboard type) associated with the acquired user identification information. The display control unit 1105 causes the display unit 1500 to display the software keyboard indicated by the setting information.

### BRIEF SUMMARY

As described above, the image forming apparatus 10 includes: the display control unit 1105 that causes its display to selectively display one of the software keyboards of different types; the information acquiring unit 1101 that acquires, from a terminal device 20, the user ID for identifying the user of the terminal device 20, and the keyboard specifying information for specifying the software keyboard being used in the terminal device 20; the selecting unit 1102 that selects a software keyboard from among the software keyboards, on the basis of the acquired keyboard specifying information; the associating unit 1103 that associates the keyboard identification information for identifying the selected software keyboard with the acquired user ID, and stores the keyboard identification information and the user ID into the storage unit 1107; and the input receiving unit 1104 that receives an input of the user ID. When the input receiving unit 1104 receives an input of the user ID after the association is completed, the display control unit 1105 causes the display unit 1500 to display the software keyboard having the keyboard identification information associated with the user ID.

With such a configuration, the image forming apparatus 10 can display a software keyboard familiar to the user in an automatic manner (without the user performing a software keyboard setting operation).

Typically, the information acquiring unit 1101 acquires keyboard specifying information from the terminal device 20, using an application program that is installed in the terminal device 20 and causes the image forming apparatus 10 to execute a job. Since such an application program has a function to transmit keyboard specifying information to an image forming apparatus, the user does not need to take the trouble of installing a new application program.

Typically, keyboard specifying information includes MIB information. MIB information is used in a network management mechanism called Simple Network Management Protocol (SNMP). Further, MIB information is included in a terminal device that uses Transmission Control Protocol/Internet Protocol (TCP/IP). In this manner, the use of MIB information enables a simple configuration to display a software keyboard to the user's liking.

A briefer description of the image forming apparatus 10 is as follows. The image forming apparatus 10 includes: the display control unit 1105 that causes its display to selectively display one of the software keyboards of different types; the information acquiring unit 1101 that acquires, from a terminal device 20, the keyboard specifying information for specifying the software keyboard being used in the terminal device 20; and the selecting unit 1102 that selects one software keyboard from among the software keyboards, on the basis of the acquired keyboard specifying information. The display control unit 1105 causes the display unit 1500 to display the software keyboard selected by the selecting unit 1102. Specifically, the display control unit 1105 refers to the data table D4 generated on the basis of selection made by the selecting unit 1102 (the data table D4 in which the selected keyboard is registered), and causes the display unit 1500 to display one software keyboard (which is the software keyboard selected by the selecting unit 1102 at the time of the registration described above).

Note that the series of processes is typically performed by the image forming apparatus 10 (more specifically, the CPU 311) executing a program (an installed program) stored beforehand in the image forming apparatus 10.

### D2. Process in a Case Where the Software Keyboard Cannot be Specified

Depending on the contents of the keyboard specifying information sent from a terminal device 20, the image forming apparatus 10 might not be able to select any software keyboard. To cope with such a case, the image forming apparatus 10 has the functions described below.

In a case where any software keyboard cannot be selected from a plurality of software keyboards on the basis of MIB information, the selecting unit 1102 narrows the plurality of software keyboards down to a plurality of candidates on the basis of the MIB information.

The display control unit 1105 causes the display unit 1500 to display information about the plurality of candidates to which the plurality of software keyboards has been narrowed down.

After the information about the plurality of candidates is displayed on the display unit 1500, the input receiving unit 1104 further receives an input for selecting one candidate from the plurality of candidates.

The associating unit 1103 associates the information for identifying the selected candidate as the keyboard identification information with the acquired user ID, and stores the information and the user ID into the storage unit 1107. Specifically, the associating unit 1103 writes the information for identifying the selected candidate in the field corresponding to the same user ID as the acquired user ID, in the data table D4.

With such a configuration, even in a case where the image forming apparatus 10 has failed to select any software keyboard, one software keyboard is eventually associated with a user ID and is stored together with the user ID.

Alternatively, the image forming system 1 may be designed so that information about a plurality of candidates to which a plurality of software keyboards has been narrowed down is displayed on a terminal device 20, and the terminal device 20 receives an input for selecting one candidate from the plurality of candidates. In this case, information about the selected candidate is transmitted from the terminal device 20 to the image forming apparatus 10.

### D3. Setting of Operation Sound

In the image forming apparatus 10, not only a software keyboard can have a mode suitable for the settings in a terminal device 20, but also the operation sound of the software keyboard can have a mode suitable for the settings in the terminal device 20. In the description below, this aspect will be described.

The image forming apparatus 10 stores a plurality of keyboard operation sounds.

The operation sound output control unit 1106 cause the speaker 1400 to selectively output one of the operation sounds (keyboard operation sounds) of different types.

The information acquiring unit 1101 further acquires, from a terminal device 20, operation sound specifying information for specifying the operation sound being used in the terminal device 20.

On the basis of the acquired operation sound specifying information, the selecting unit 1102 further selects one operation sound from the plurality of operation sounds.

As shown in FIG. 4, the associating unit 1103 associates the keyboard identification information, the user ID, and the operation sound identification information for identifying the selected operation sound with one another, and stores the keyboard identification information, the user ID, and the operation sound identification information into the data table D4 in the storage unit 1107.

After the display control unit 1105 causes the display unit 1500 to display the software keyboard having the keyboard identification information associated with the user ID, the operation sound output control unit 1106 causes the speaker 1400 to output the operation sound having the operation sound identification information associated with the user ID, every time a key of the software keyboard is used.

With such a configuration, the image forming apparatus 10 can output a keyboard operation sound familiar to the user.

### D4. Setting of Screen Luminance Level

In the image forming apparatus 10, not only a software keyboard can have a mode suitable for the settings in a terminal device 20, but also the luminance level of the display (the display unit 1500) of the operation panel 34 can have a mode suitable for the settings in the terminal device 20. In the description below, this aspect will be described.

The information acquiring unit 1101 further acquires, from a terminal device 20, screen setting information indicating the screen luminance that is set in the terminal device 20.

As shown in FIG. 4, the associating unit 1103 associates the keyboard identification information, the user identification information, and the screen setting information with one another, and stores the keyboard identification information, the user identification information, and the screen setting information into the data table D4 in storage unit 1107.

When the input receiving unit 1104 receives an input of the user ID after the association is made, the display control unit 1105 adjusts the luminance of the display unit 1500, on the basis of the screen setting information associated with the user ID.

With such a configuration, the image forming apparatus 10 can cause the display unit 1500 to display the software keyboard at the luminance level to the user's liking

### E. User Interface

In the description below, a user interface in a case where a software keyboard to the user's liking is displayed on the basis of the data table D4 after the registration of keyboard identification information is completed is described.

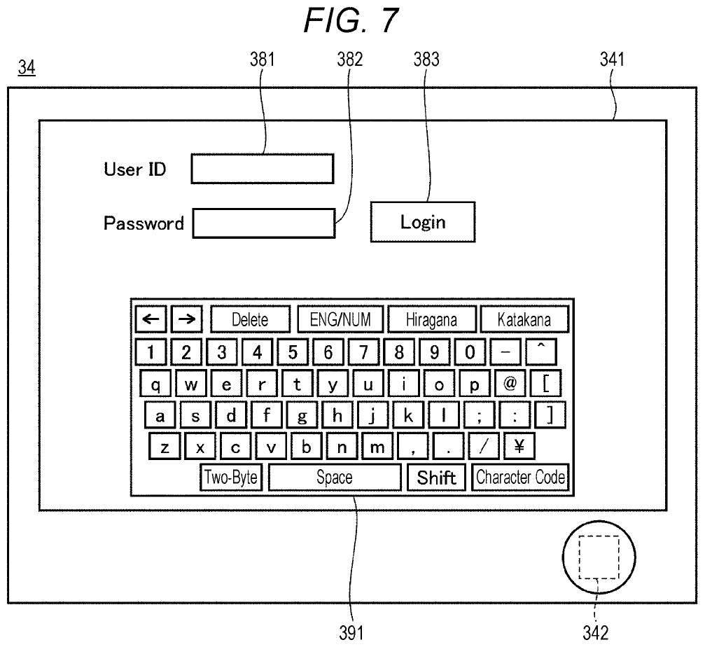

FIG. 7 is a diagram showing an example of the user interface of the operation panel 34 of the image forming apparatus 10. Specifically, FIG. 7 is a diagram showing a screen for logging in to the image forming apparatus 10.

As shown in FIG. 7, the controller 31 causes the touch screen 341 of the operation panel 34 to display a user ID input field 381, a password input field 382, a software button 383 for completing a login process, and a software keyboard 391.

The software keyboard 391 is a QWERTY keyboard for the English language. This is because a keyboard for the English language is preferable in inputting a user ID and a password.

When the user presses the software button 383 after inputting a user ID and a password, the controller 31 performs authentication (individual authentication). If the authentication is successful, the controller 31 changes the screen on the touch screen 341.

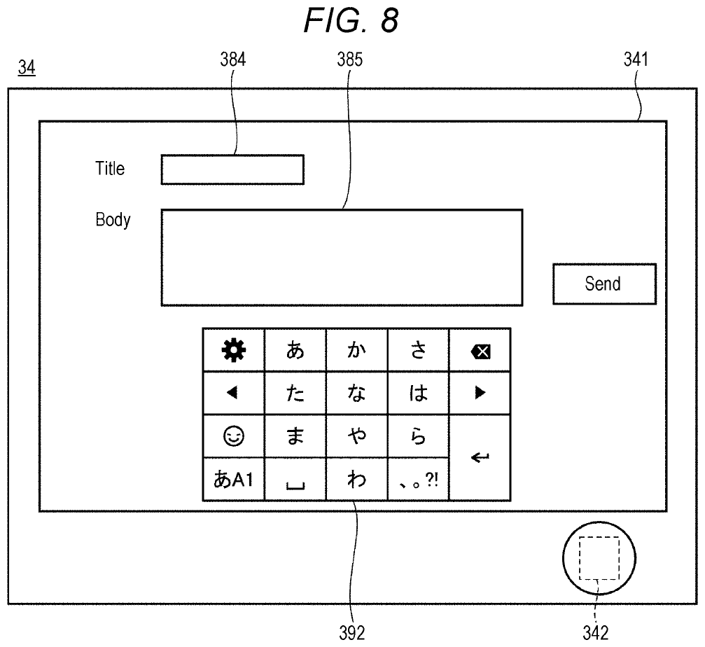

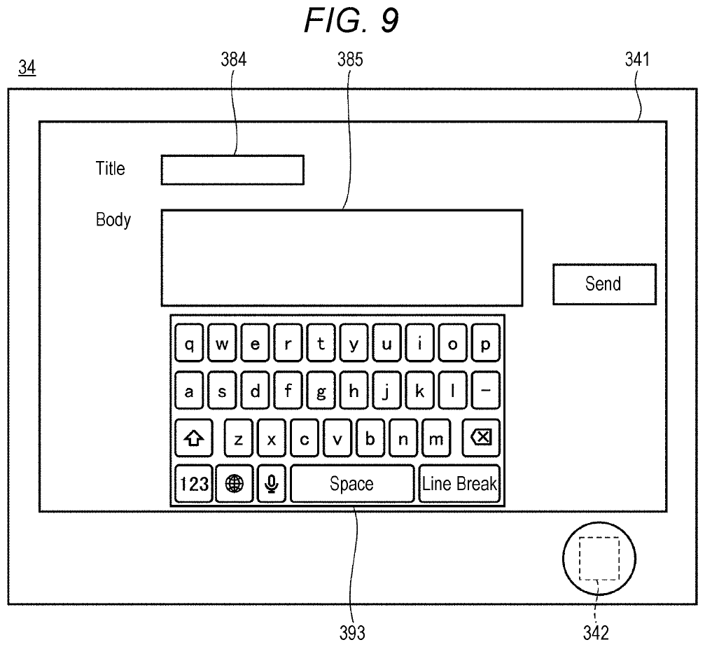

FIGS. 8 and 9 are diagrams each showing a state in which the image forming apparatus 10 displays an e-mail creation screen after successful login.

In a case where “No. 2” (see FIG. 4) is registered as the keyboard identification information associated with the user ID used at the time of login in the data table D4, the controller 31 refers to the data table D5, and causes the touch screen 341 to display an Android version of a Japanese numeric keypad 392 (a software keyboard), as shown in FIG. 8.

In this case, the user can use the numeric keypad 392 to write in a text box 384 for the title of the mail, a text box 385 for the body, and the like.

In a case where “No. 5” (see FIG. 4) is registered as the keyboard identification information associated with the user ID used at the time of login in the data table D4, the controller 31 refers to the data table D5, and causes the touch screen 341 to display an iOS version of a QWERTY keyboard 393 (a software keyboard) for inputting Japanese romaji, as shown in FIG. 9.

In this case, the user can use the QWERTY keyboard 393 to write in the text box 384 for the title of the mail, the text box 385 for the body, and the like.

### F. Control Structure

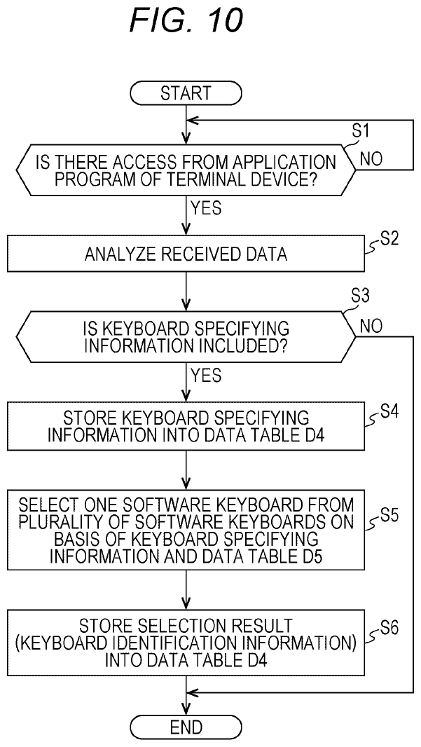

FIG. 10 is a flowchart for explaining the flow of a process to be performed in the image forming apparatus 10. Specifically, FIG. 10 is a flowchart showing the flow of a process for storing keyboard identification information into the data table D4.

As shown in FIG. 10, in step S1, the controller 31 (more specifically, the CPU 311) determines whether access has been made from the application program of a terminal device 20. If it is determined that access has been made (YES in step S1), the controller 31 in step S2 analyzes the data received through the access. If no access has been made (NO in step S1), the controller 31 returns to the process in step S1.

In step S3, the controller 31 determines whether keyboard specifying information (MIB information, for example) is included in the received data. If it is determined that keyboard specifying information is included (YES in step S3), the controller 31 stores the keyboard specifying information into the data table D4 in step S4. If it is determined that any keyboard specifying information is not included (NO in step S3), the controller 31 ends the series of processes.

In step S5, the controller 31 selects a software keyboard from a plurality of software keyboards, on the basis of the keyboard specifying information and the data table D5. In step S6, the controller 31 associates keyboard identification information as a selection result with the user ID, and stores the keyboard identification information and the user ID into the data table D4.

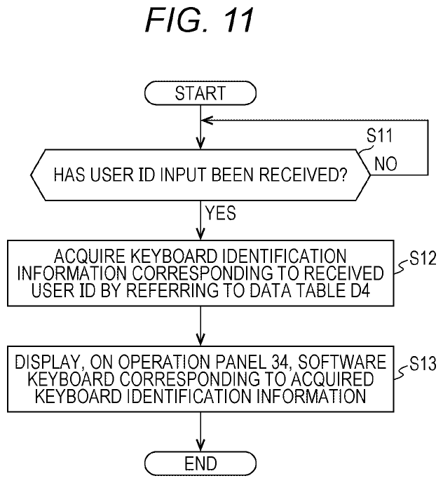

FIG. 11 is a flowchart for explaining the flow of a process to be performed in the image forming apparatus 10. Specifically, FIG. 11 is a flowchart showing the flow of a process for causing the touch screen 341 to display a software keyboard to the user's liking, using the data table D4.

As shown in FIG. 11, in step S11, the controller 31 determines whether an input of a user ID has been received. A user ID is input by near field communication using the touch screen 341 of the operation panel 34 or the communication circuit 342, for example. Alternatively, a user ID is input to the controller 31 (the control unit 1100) from a terminal device 20 via the network 50 and the communication interface unit 1300.

In step S12, the controller 31 refers to the data table D4, and acquires (reads out) the keyboard identification information associated with the received user ID. In step S13, the controller 31 causes the touch screen 341 of the operation panel 34 to display the software keyboard associated with the acquired keyboard identification information.

As described above, a software keyboard familiar to the user can be automatically displayed on the image forming apparatus 10.

Although embodiments of the present disclosure have been described and illustrated in detail, the disclosed embodiments are made for purposes of illustration and example only and not limitation. The scope of the present disclosure should be interpreted by terms of the appended claims, and it should be understood that equivalents and modifications thereof are incorporated herein.

As used herein, the words “can” and “may” are used in a permissive (i.e., meaning having the potential to), rather than mandatory sense (i.e., meaning must). The words “include,” “includes,” “including,” and the like mean including, but not limited to. Similarly, the singular form of “a” and “the” include plural references unless the context clearly dictates otherwise. And the term “number” shall mean one or an integer greater than one (i.e., a plurality).

What is claimed is:

1. An information processing apparatus capable of communicating with a terminal device, the information processing apparatus comprising a hardware processor that:
causes a display to selectively display one software keyboard of a plurality of software keyboards of different types;
acquires, from the terminal device, first specifying information for specifying a software keyboard being used in the terminal device;
selects, from among the plurality of software keyboards, one software keyboard based on the acquired first specifying information; and
causes the display to display the selected software keyboard.

2. The information processing apparatus according to claim 1, wherein:
the hardware processor further acquires user identification information for identifying a user of the terminal device,
the hardware processor associates keyboard identification information, for identifying the selected software keyboard with the acquired user identification information, and stores the keyboard identification information and the acquired user identification information into a memory,
the hardware processor receives an input of the user identification information, and
when the hardware processor receives the input of the user identification information after the association is made, the hardware processor causes the display to display a software keyboard having the keyboard identification information associated with the user identification information as the selected software keyboard.

3. The information processing apparatus according to claim 2, wherein the first specifying information is at least one information piece of language information about the software keyboard being used in the terminal device, type information about an operating system of the terminal device, and an input method of the software keyboard being used in the terminal device.

4. The information processing apparatus according to claim 2, wherein:
the information processing apparatus is an image forming apparatus, and
the hardware processor acquires the first specifying information from the terminal device, using an application program that is installed in the terminal device, and causes the image forming apparatus to execute a job.

5. The information processing apparatus according to claim 2, wherein the first specifying information includes management information base (MIB) information.

6. The information processing apparatus according to claim 5, wherein:
when the hardware processor is unable to select one software keyboard from the plurality of software keyboards based on the MIB information, the hardware processor narrows the plurality of software keyboards down to a plurality of candidates based on the MIB information,
the hardware processor causes the display to display information about the plurality of candidates to which the plurality of software keyboards has been narrowed down,
the hardware processor further receives an input for selecting one candidate from the plurality of candidates, after the information about the plurality of candidates is displayed on the display, and
the hardware processor associates information for identifying the selected candidate as the keyboard identification information with the acquired user identification information, and stores the keyboard identification information and the acquired user identification information into the memory.

7. The information processing apparatus according to claim 2, wherein the hardware processor receives the input of the user identification information, using near field communication.

8. The information processing apparatus according to claim 2, wherein:
the hardware processor further causes a speaker to selectively output one keyboard operation sound of a plurality of keyboard operation sounds of different types,
the hardware processor further acquires, from the terminal device, second specifying information for specifying an operation sound being used in the terminal device,
the hardware processor further selects one operation sound from the plurality of operation sounds based on the acquired second specifying information,
the hardware processor associates the keyboard identification information, the user identification information, and operation sound identification information for identifying the selected operation sound with one another, and stores the keyboard identification information, the user identification information, and the operation sound identification information into the memory, and
when the hardware processor causes the display to display a software keyboard having the keyboard identification information associated with user identification information, the hardware processor causes the speaker to output an operation sound having the operation sound identification information associated with the user identification information, every time a key of the software keyboard is used.

9. The information processing apparatus according to claim 2, wherein:
the hardware processor further acquires, from the terminal device, screen setting information indicating screen luminance that is set in the terminal device,
the hardware processor associates the keyboard identification information, the user identification information, and the screen setting information with one another, and stores the keyboard identification information, the user identification information, and the screen setting information into the memory, and
when the hardware processor receives the input of the user identification information after the association is made, the hardware processor adjusts luminance of the display based on the screen setting information associated with the user identification information.

10. A method of displaying a software keyboard in an information processing apparatus, the method comprising:
acquiring, from a terminal device, specifying information for specifying a software keyboard being used in the terminal device;
selecting, from among a plurality of the software keyboards, one software keyboard based on the acquired specifying information; and
causing a display to display the selected software keyboard,
performing, via the information processing apparatus, the acquiring of the specifying information, the selecting of the one software keyboard, and the causing of the display to display the selected software keyboard.

11. A non-transitory recording medium storing a computer readable program for causing an information processing apparatus to display a software keyboard, the program causing the hardware processor of the information processing apparatus to perform:
acquiring, from a terminal device, specifying information for specifying a software keyboard being used in the terminal device;
selecting, from among a plurality of the software keyboards, one software keyboard based on the acquired specifying information; and
causing a display to display the selected software keyboard.
